(19) United States
(12) Patent Application Publication
(10) Pub. No.: US 2009/0200705 A1
(43) Pub. Date: Aug. 13, 2009

(54) Method of Manufacturing a Pipe Gasket

(75) Inventor: Herberth Mora, San Jose (CR)

Correspondence Address: WHITAKER, CHALK, SWINDLE & SAWYER, LLP, 3500 CITY CENTER TOWER II, 301 COMMERCE STREET, FORT WORTH, TX, 76102-4186, US

(73) Assignee: S & B Technical Products, Inc., Fort Worth, TX (US)

(21) Appl. No.: 12/358,444

(22) Filed: Jan. 23, 2009

Related U.S. Application Data
(60) Provisional application No. 61/028,228, filed on Feb. 13, 2008.

(51) Int. Cl. B29C 45/14

(52) U.S. Cl. 264/275

(57) ABSTRACT

A pipe sealing gasket is shown which is designed to be received within a groove provided within a socket end of a thermoplastic pipe such as PVC pipe used in municipal water and sewer installations. The gasket has a ring shaped body of an elastomeric material and includes a metal reinforcing band. The metal reinforcing band is entirely embedded within the body of elastomeric material during the gasket manufacturing process.

### CROSS-REFERENCE TO RELATED APPLICATION

The present application claims priority from earlier filed provisional application Ser. No. 61/028,228, filed Feb. 13, 2008, entitled “Method of Manufacturing a Pipe Gasket” by inventor, Herberth Mora.

### BACKGROUND OF THE INVENTION

1. Field of the Invention:

The present invention relates generally to sealing gaskets used for pipe joints in which a male spigot pipe section is installed within a mating female socket pipe section and to an improved method for manufacturing such sealing gaskets.

2. Description of the Prior Art:

Pipes formed from thermoplastic materials including polyethylene, polypropylene and PVC are used in a variety of industries. For example, such pipes are commonly used in municipal water and sewer applications. In forming a joint between sections of pipe, the spigot or male pipe end is inserted within the female or socket pipe end. An annular, elastomeric ring or gasket is typically seated within a grove formed in the socket end of the thermoplastic pipe. As the spigot is inserted within the socket, the gasket provides the major seal capacity for the joint.

Irrespective of the type of sealing action of the sealing element, such as compression sealing action, lip sealing action or a combination thereof, it is necessary that the sealing gasket consists of a relatively soft elastomeric material. However, a sealing ring which is formed entirely of a material which is sufficiently soft and elastomeric to provide the sealing function has the disadvantage that it is difficult to retain in the desired position in a groove in connection with the joining of sections of pipe. There is also the risk that such a sealing ring will be displaced from its sealing position in the pipe joint if the difference of the internal or external pressures on either side of the sealing ring are sufficiently great.

In the early 1970's, a new technology was developed by Rieber & Son of Bergen, Norway, referred to in the industry as the “Rieber Joint.” The Rieber system employed a combined mold element and sealing ring for sealing a joint between the socket end and spigot end of two cooperating pipes formed from thermoplastic materials. In the Rieber process, the elastomeric gasket was installed within a simultaneously formed internal groove in the socket end of the female pipe during the pipe belling process. The provision of a prestressed and anchored elastomeric gasket during the belling process at the pipe factory provided an improved socket end for a pipe joint with a sealing gasket which would not twist or flip or otherwise allow impurities to enter the sealing zones of the joint, thus increasing the reliability of the joint and decreasing the risk of leaks or possible failure due to abrasion. The Rieber process is described in the following issued United States patents, among others: U.S. Pat. Nos. 4,120,521; 4,061,459; 4,030,872; 3,965,715; 3,929,958; 3,887,992; 3,884,612; and 3,776,682.

From the foregoing discussion, it will be appreciated that a sealing ring of the type under consideration could be made entirely of elastically yielding material, such as rubber. Such a design would be simple and could be produced relatively easily with uncomplicated production equipment. However, as has been discussed, such sealing rings made entirely of elastically yielding material generally lack the necessary support effect to avoid being dislodged during field installation procedures and may not be suitable for use as a combined mold element in a Rieber style manufactured process, as described above. As an additional consideration, the groove provided in the female or socket pipe end may assume various shapes. The problem of retaining the sealing rings during joining of pipes is even more important in the case where the female groove has a bottom surface which is at least partly rounded in shape. In these cases, axially directed forces can create substantial twisting within the seal ring.

In order to address the above problems, different approaches have been suggested to compensate for the lack of support effect in sealing rings made of elastically yielding material. In certain of the commercially available designs, the sealing ring, in addition to the elastically yieldable material, includes either an internal or external metal retainer ring or band which is intended to support the gasket during the manufacturing operation and/or during field installation procedures and transport. In those designs utilizing external metal reinforcing bands or rings, it is possible that water, sewage waste or other contaminates could corrode the metal surfaces, thereby degrading the metal band, and in some cases even compromising the integrity of the pipe joint In the case of potable water supply systems, the deterioration of the metal band could possibly contaminate the water supply,

It is therefore an object of the present invention to provide a sealing gasket of elastically yielding material which is suitable for use as a combined mold element and sealing ring, in a Rieber type pipe belling process, while providing a reinforced region which is entirely embedded within the elastically yielding material.

Another object of the invention is to provide a sealing gasket with an embedded steel band which thereby isolates the band from deleterious effects which might otherwise be encountered if it were exposed to liquid contamination in its environment of use.

Another object of the invention is to provide a sealing gasket with an embedded metal band which features improved adhesion of the metal to the rubber of the gasket.

Another object of the invention is to provide such a gasket with an embedded band which avoids metal to water or other liquid contact in use.

Another object of the invention is to provide such a gasket design with an embedded metal band of a unique configuration which avoids metal to water contact while at the same time provides a reinforced contact point for reinforcing the gasket during a Rieber style pipe belling operation.

### SUMMARY OF THE INVENTION

In the pipe joint of the invention, a first pipe of thermoplastic material has a female, socket end including an internal annular groove and internal cylindrical surfaces on either side of the groove of substantially equal diameter. A second pipe has a male, spigot end which is installed within the socket end of the first pipe. A sealing gasket is disposed within the internal annular groove for slidingly and sealingly engaging the mating male spigot pipe end as a pipe joint is made up. The gasket is a unitary ring formed of a body of elastically yielding material, but has a relatively rigid, circumferentially continuous band located within the gasket body. The band has generally planar inner and outer surfaces and an intermediate thickness which is generally uniform. The band is wholly embedded within the body of elastically yielding material. Preferably, the elastically yielding material is either a natural or synthetic rubber and the outer surface of the band is covered with at least a thin layer of rubber so that the entire band is embedded within the body of elastically yielding material.

In the method of manufacturing a sealing gasket of the invention, a gasket is provided of the type used in forming a joint between sections of thermoplastic pipe where a male pipe end is inserted within a female end and where the sealing gasket is seated within a grove formed in an interior region of the female pipe end. In the first step in the method of the invention, a mold is provided having a first member and a mating second member, at least a selected one of which has an internal mold cavity formed by internal surfaces thereof. A relatively rigid reinforcing band is placed within the mold cavity of the selected mold member. At this point in the manufacturing process, the first mold member is united with the mating second mold member to form a sealed mold cavity. Next, a curable elastomeric material is injected into the sealed mold cavity and cured to form a finished sealing gasket. The reinforcing band which is placed within the mold cavity is supported by a series of pin-shaped projections formed within the interior of the mold cavity, whereby the band is spaced away from the mold internal surfaces during the manufacturing process, thereby allowing the band to be encapsulated as the elastomeric material cures.

Preferably, the reinforcing band is formed of metal such as steel. The mold cavity which is used has a bottom surface and a surrounding continuous sidewall. The pin-shaped projections formed on the bottom surface and surrounding sidewall of the mold cavity extend into contact with the reinforcing band, causing the band to be spaced apart from both the bottom surface of the mold cavity and the surrounding sidewall. Since the reinforcing band is spaced apart from both the bottom wall cavity and from the surrounding sidewall, the band is left completely encapsulated within the material of the elastomeric body of the gasket during the subsequent manufacturing operations.

In the method of forming a seal structure in the female pipe end of a section of thermoplastic pipe, a mold is provided having a first member and a mating second member, at least a selected one of which has an internal mold cavity formed by internal surfaces thereof. A rigid reinforcing band is placed within the mold cavity of the selected mold member. The reinforcing band which is placed within the mold cavity is supported by a series of pin-shaped projections formed within the interior of the mold cavity, whereby the band is spaced away from the mold internal surfaces during the manufacturing process. The first and second mold members are then united to form a sealed mold cavity. Next, a curable elastomeric material is injected into the sealed mold cavity and subsequently cured to form a finished sealing gasket. The gasket so formed is then installed on a forming mandrel, the gasket being seated against a forming collar. A section of thermoplastic pipe is then heated and a mouth opening of the section of pipe is forced over the previously installed gasket to thereby deform an interior surface of the heated pipe. Next, the section of pipe is cooled so that the heated pipe contracts about the gasket with the deformed interior surface of the female belled pipe end. Finally, the pipe with the previously installed gasket is removed from the forming mandrel. At the end of the manufacturing process, the band is located in proximity with an outer surface of the gasket body, but is completely encapsulated within the elastomeric material.

Additional objects, features and advantages will be apparent in the written description which follows.

### BRIEF DESCRIPTION OF THE DRAWINGS

FIG. 1 is a partial, prospective view, partly broken away showing the pipe joint of the invention in which a male spigot pipe end is inserted within a female socket end, the female socket end having a groove for receiving the sealing gasket of the invention;

FIG. 2 is a cross-sectional view of a typical gasket of the invention showing the embedded band therein;

FIG. 3 is a side, cross-sectional view of the female socket end of the pipe showing the gasket of FIG. 2 in the compressed, made-up state, the male spigot end being indicated by the phantom lines.

FIGS. 4-7 are simplified, schematic illustrations of the prior art Rieber process for installing a sealing gasket within a groove formed within the female socket end of a thermoplastic pipe.

FIG. 8 is a simplified, schematic view of an injection molding operation of the type used to form the gaskets of the invention.

FIG. 9 is a simplified, partial sectional view of the lower mold element or platen of the type used in a prior art gasket manufacturing process.

FIG. 10 is a view similar to FIG. 9, but showing the improved manufacturing process of the invention in which an internal reinforcing band is placed in the lower mold element of the injection molding machine, the mold cavity being provided with a series of pin-shaped projections formed within the interior thereof, whereby the band is spaced away from the mold interior surfaces during subsequent manufacturing steps.

### DETAILED DESCRIPTION OF THE INVENTION

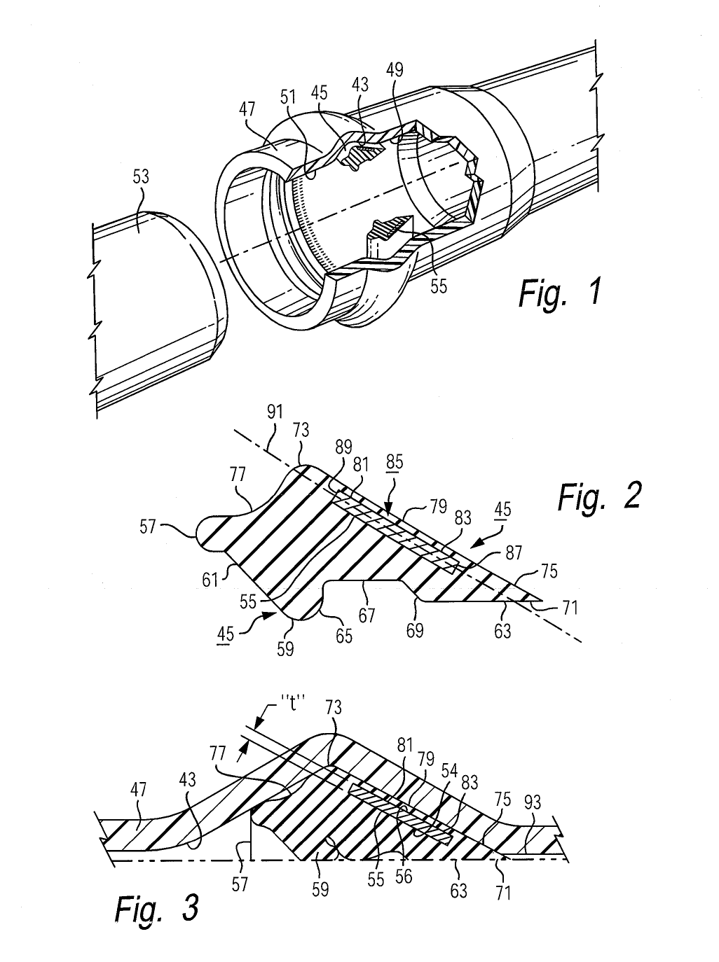

Turning to FIG. 1 of the drawings, there is shown a sealing gasket of the invention, designated generally as 45 which is installed within a groove 43 provided within the socket end 47 of the illustrated thermoplastic pipe. As shown in FIG. 1, the internal annular groove 43 of the socket end 47 is located between internal cylindrical surfaces 49, 51 of substantially equal diameter. The socket end 47 is intended to be made-up to form a pipe joint with the mating male or spigot pipe section 53 which is inserted within the socket end 47. The sealing gasket 45, as shown in FIG. 1, is disposed within the groove 43 wholly between the cylindrical surfaces concentrically between and sealingly engaging the pipe insert end 53 and the pipe socket end 47 (see FIG. 3) when the joint is made up.

FIG. 2 shows a typical gasket of the invention in enlarged cross-section for ease of illustration. The gasket 45 is a unitary ring formed of a body of elastically yielding material having a rigid circumferentially continuous band 55 which is now located entirely within the elastomeric material of the gasket body. In the example shown, the gasket 45 includes a leading nose region 57 and a lower compression region 59. The leading nose region 57 is joined to the lower compression region 59 by a leading curved surface region 61. The lower compression region 59 is also joined to a secondary seal surface 63 by a trailing curved surface region 65 and an intermediate circumferential groove region 67. The groove region 67 includes an outer wall 69 which forms an obtuse angle with respect to the remainder of the groove region.

The secondary seal surface 63 is a planar circumferential region which terminates an inside corner 71 of the gasket 45. The inside corner 71 is connected to an outer arcuate region 73 of the gasket 45 by uniformly sloping exterior gasket surface 75. The outer arcuate region 73 is connected to the nose region 57 of the gasket by a concave curved region 77.

The gasket thus comprises a unitary ring formed of a body of elastically yielding material, but has a relatively rigid, circumferentially continuous band located within the gasket body. As shown in FIGS. 2 and 3, the band 55, in this case formed of steel, runs through the interior of the gasket about the diameter thereof and thus serves as a metal reinforcing element. The circumferential band 55 has generally planar inner and outer surfaces, 54, 56 (FIG. 3), respectively, and an intermediate thickness (“t” in FIG. 3) which is generally uniform. The band is wholly embedded within the body of elastically yielding material. Preferably, the elastically yielding material is either a natural or synthetic rubber and the outer surface of the band is covered with at least a thin layer of rubber so that the entire band is embedded within the body of elastically yielding material. In the example shown, at least about 1 mm of rubber covers the outer planar surface 56 of the band.

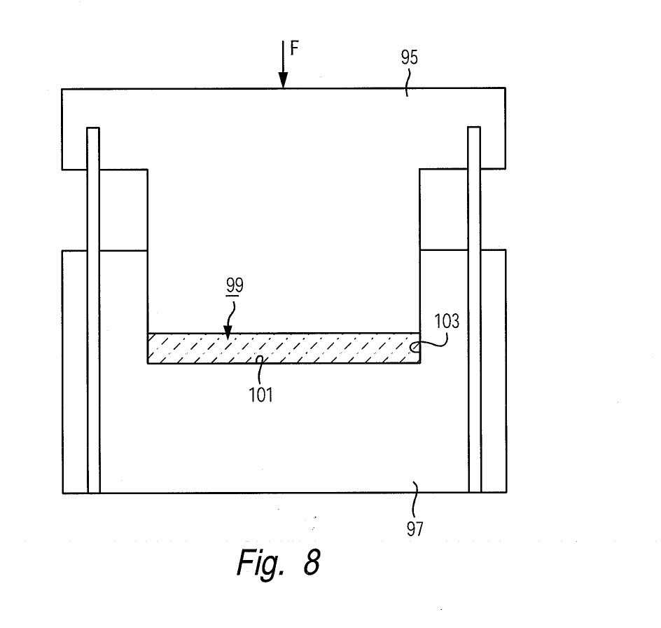

The process for manufacturing the gasket with the embedded band of the invention will now be described. Turning to FIG. 8, there is shown in simplified fashion, a traditional compression injection molding process. Injection molding processes of this type will be well familiar to those skilled in the relevant arts. The device in FIG. 8 comprises an upper mold member or platen 95 and a lower mold member 97. The lower mold element 97 has a mold cavity 99 which is made up of a bottom wall 101 and surrounding sidewalls 103. During the manufacturing process, a curable elastomeric material is placed in the hot mold cavity and pressure is applied by bringing the upper and lower mold elements into contact to thereby cause the material in the mold to conform to the contour of the mold. Since molding pressures are high in many cases, the molding pressure may be applied by direct hydraulic pressure or a combination of hydraulic, air, or steam pressure. In a typical operation, the mold cavity is mounted on the lower movable platen, and the plunger or force, is attached to the top or fixed platen. Molds may be single or multiple cavity, depending upon the part being produced.

In manually operated presses, the molds are filled and the finished products removed by hand. The molding time is controlled by hand-operated valves. The common semi-automatic press controls the time cycle automatically. Finished pieces are typically ejected from the mold by knock-out pins or the like, but must be removed by the operator. The fully automatic presses control the time, temperature, and pressure automatically and the operator generally only needs to fill the hopper periodically with raw molding material.

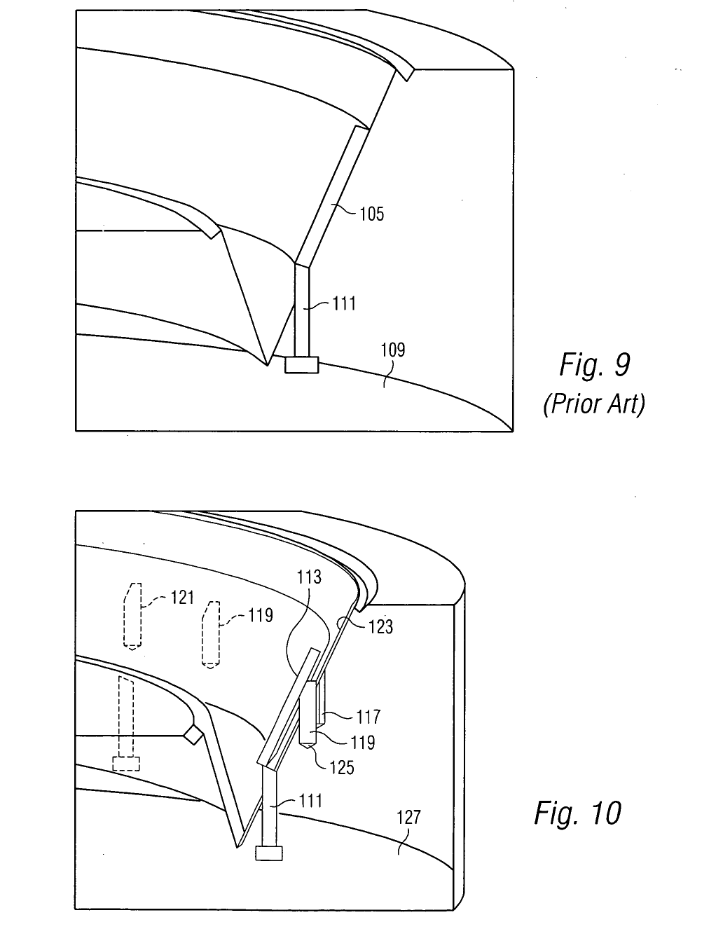

FIG. 9 is a simplified representation of section of a prior art mold showing the placement of the steel reinforcing band 105 adjacent the sidewalls 107 of the mold cavity formed in the lower mold element. As can be appreciated from FIG. 9, the band 105 is supported above the bottom surface 109 of the mold cavity by means of a plurality of upright pins 111 which are mounted in circumferential fashion about the periphery of the mold sidewalls 107 adjacent the bottom surface 109. In this way, the band 105 is supported a predetermined distance above the bottom surface 109, but makes full contact with the sidewall 107 of the mold cavity. Once the curable elastomer is introduced into the mold cavity and the injection molding operation is complete, the finished gasket body will have the band 105 located on an external circumferential surface, the outer planar surface of which will be exposed to the environment in use. The band is also typically coated with a commercially available rubber to metal bonding agent or adhesive which will be selected depending upon the particular elastomer used, the type of material selected for the band, etc.

FIG. 10 shows the improved manufacturing process of the invention in which the band 113 is now supported by a plurality of upwardly extending pins (115, 117, 119, 121 shown) which are attached to or formed as a part of the sidewalls 123 of the surrounding mold cavity. The pins are generally equi-distantly spaced about the circumference of the band 113 and have lower extents 125 which are attached to the surrounding sidewalls 123 in order to space the band 113 away from the sidewalls a slight distance. The pins 115, 117, 119, 121 are generally aligned along a vertical axis which is approximately parallel to the axis of the support pins 111 which extend upwardly from the bottom surface 127 of the mold cavity. While the spacing distance of the reinforcing band from the surrounding sidewall of the mold cavity is not particularly critical, it will generally be sufficient to provide at least about 1 mm of rubber covering the outer planar surface of the band 113, so that the band is completely embedded within the rubber of the gasket body. The original bottom surface support pins 111 continue to support the band 113 above the bottom surface 127 of the mold cavity. By providing the additional spacing pins 115, 117, 119, 121, which are attached to or formed on the sidewall surfaces 123 of the surrounding mold cavity, the reinforcing band is totally encapsulated during the molding operation, thereby insuring that the band will not be subject to attack by corrosive elements in the environment of use.

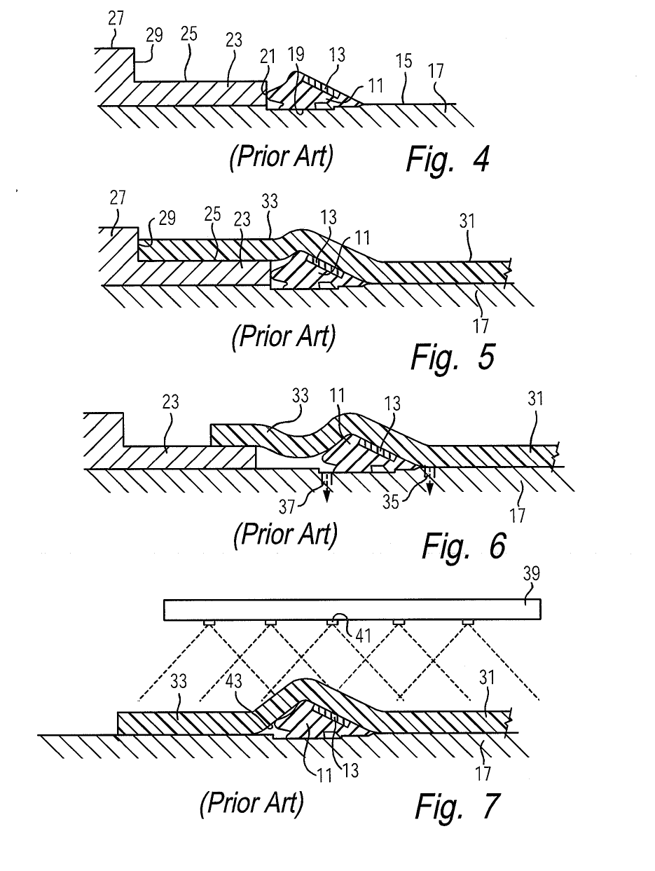

The improved gaskets of the invention will typically be utilized in a “Rieber” type plastic pipe belling operation. In order to fully appreciate the advantages provided by the improved pipe gasket of the invention, the prior art Rieber manufacturing process will be briefly described. Turning first to FIGS. 4-7, the Rieber process is illustrated showing the installation of a prior art compression seal gasket within the groove provided within the socket end of the female pipe section.

FIG. 4 shows an elastomeric sealing gasket 11 which in this case has an exposed reinforcing band 13 It is the exposed, or partly exposed metal band 13 which is the subject of the improvement of the present invention The gasket 11 is shown installed on the generally cylindrical outer working surface 15 of the mandrel 17 used in the belling process. The elastomeric gasket 11 can be formed of, for example, a natural or synthetic rubber and is a ring shaped, circumferential member having a lower compression region 19 and an exposed nose portion 21 which, as shown in FIG. 4 abuts a back-up or forming collar 23. The forming collar 23 has a first generally cylindrical extent 25 which is a joined to a second cylindrical extent 27 by a step region 29, whereby the first extent 27 is of greater external diameter than the first cylindrical extent 25, as shown in FIG. 4. When mounted against the back-up or forming collar 23, the gasket is firmly anchored to the mandrel surface.

In the second step of the process, the socket end 33 of a thermoplastic pipe 31 is heated and pushed over the steel mandrel 17, gasket 11 and back-up collar 23. The socket end is expanded due to the thermoplastic nature of the pipe. A number of thermoplastic materials, such as polyethylene, polypropylene and polyvinyl chloride (PVC) are known in the prior art having the required expansion characteristics, depending upon the end application of the pipe joint. The preferred material is typically PVC.

The socket end 33 flows over the first cylindrical extent 25 of the back-up collar 23 and abuts the step region 29 in the second step of the process. In the next step of the process (FIG. 6) the mandrel and pipe move away from the back-up collar 23 and the pipe socket end 33 retracts around the mandrel and gasket 11 due to the elastic forces of the thermoplastic material. Typically, vacuum is also supplied through ports 35, 37 which connect the mandrel working surface with a vacuum source (not shown).

In the last step of the process (FIG. 7) the pipe socket end 33 is cooled by means of a water spray bar 39 and spray nozzles 41. As the cooling takes place, the pipe socket end 33 shrinks around the gasket 11, thus compressing the rubber body of the gasket between the steel reinforcing band 13 and the socket-groove to establish a firm seal. Since the gasket is prelocated within the socket groove under controlled conditions at the factory, the possibility that sand or similar contaminants might penetrate the crucial sealing zone of the gasket is greatly reduced. The external reinforcing metal band 13, in addition to assisting in providing the required rigidity during the manufacturing process described, also functions as a retainer to insure that the gasket is not displaced from the ultimate pipe groove (43 in FIG. 7) during transport or installation.

The above-described Rieber process has been in commercial use since the early 1970's and is described in the above referenced issued United States patents, among other sources. It will thus be well familiar to those skilled in the thermoplastic pipe sealing arts. The improved gasket of the invention with its totally embedded band can be easily substituted for the gasket with the external band shown in FIGS. 4-7.

Referring now to FIG. 1, the make-up of a pipe joint using one of the improved gaskets of the invention will now be described. The make-up operation requires the insertion of the male spigot pipe section 53 within the mouth opening of the female socket end 47. As the male spigot end 53 passes over the gasket region, the compression region 59 of the sealing gasket 45 is compressed to approximately the horizontal axis 93 (FIG. 3). During the installation operation in which the male spigot end 53 is inserted within the female socket end 47, the reinforcing band 55 helps to retain the gasket 45 in position within the groove 43, thereby insuring that the gasket is not displaced or dislodged during the installation procedure. While the gasket continues to provide a reinforced contact point to facilitate the belling operation, the metallic reinforcing element is separated by at least a thin wall of rubber from the surrounding environment. Since the pipe joints of the invention are often used in water or sewage transport systems, isolating the metallic reinforcing element prevents any possible corrosion of the element which might adversely affect the integrity of the joint.

An invention has been provided with several advantages. The gasket of the invention is simple in design and economical to manufacture. The design features a metal reinforced elastomeric body which allows it to serve as a combined mold element and sealing structure. In other words, the reinforced gasket can be placed on a forming mandrel with the heated thermoplastic pipe forced over and about the gasket to create the gasket groove during the manufacturing operation without dislodging the gasket. Additionally, the reinforcing element helps to retain the gasket in position once the belling operation is completed to insure that the gasket is not dislodged or displaced during storage, transportation or field installation. Because the reinforcing element is embedded within the elastomeric body of the gasket, it is entirely isolated from the external environment including water, sewage or other fluids flowing through the pipe joint. As such, the metal reinforcing element is not subject to corrosion or deterioration by contact with liquids.

The prior art manufacturing processes which produced external reinforcing bands generally required that the band be coated with a rubber/metal adhesive of some type. During the molding operation, the adhesive tended to separate and come off in the mold, requiring frequent cleaning of the mold cavity surfaces. The improved process isolates the band and any adhesives and allows the manufacturing process to continue for a much longer period of time, without requiring cleaning of the mold surfaces. Also, any rubber to metal bonding chemicals are taken out of contact with fluids passing through the plastic pipes in question. It may also be possible to reduce the amount of metal used in the band using the improved manufacturing process, as compared with the prior art external banded gaskets.

While the invention has been shown in only one of its forms, it is not thus limited but is susceptible to various changes and modifications without departing from the spirit thereof.

What is claimed is:

1. A method of manufacturing a sealing gasket of the type used in forming a joint between sections of thermoplastic pipe where a male pipe end is inserted within a female end and where the sealing gasket is seated within a grove formed in an interior region of the female pipe end, the method comprising the steps of:
providing a mold having a first member and a mating second member, at least a selected one of which has an internal mold cavity formed by internal surfaces thereof;
placing a rigid reinforcing band within the mold cavity of the selected mold member;
uniting the first mold member and the mating second mold member to form a sealed mold cavity;
injecting a curable elastomeric material into the sealed mold cavity and curing the material to form a finished sealing gasket; and
wherein the reinforcing band which is placed within the mold cavity is supported within the mold cavity by a series of pin-shaped projections formed on the internal surfaces of the mold cavity, whereby the band is spaced away from the mold internal surfaces during the manufacturing process.

2. The method of claim 1, wherein the reinforcing band is formed of metal.

3. The method of claim 2, wherein the curable elastomeric material is selected from the group consisting of natural and synthetic rubbers.

4. The method of claim 1, wherein the mold cavity internal surfaces include a bottom surface and a surrounding sidewall, and wherein the pin-shaped projections extend from both the bottom surface and the sidewall of the mold cavity.

5. The method of claim 4, wherein the pin-shaped projections on the reinforcing band form minute openings in the surrounding curable elastomeric material as the material is injected into the mold, and wherein the elastomeric material seals up around the openings during the subsequent curing operation.

6. A method of forming a seal structure in the female pipe end of a section of thermoplastic pipe, the method comprising the steps of
providing a mold having a first member and a mating second member, at least a selected one of which has an internal mold cavity formed by internal surfaces thereof,
placing a rigid reinforcing band within the mold cavity of the selected mold member, wherein the reinforcing band which is placed within the mold cavity is supported within the mold cavity by a series of pin-shaped projections formed thereon, whereby the band is spaced away from the mold internal surfaces during the manufacturing process;
uniting the first mold member and the mating second mold member to form a sealed mold cavity;
injecting a curable elastomeric material into the sealed mold cavity and subsequently curing the material to form a finished sealing gasket;
installing the sealing gasket so formed on a forming mandrel, the gasket being seated against a forming collar;
heating a section of thermoplastic pipe and forcing a mouth opening of the section of pipe over the previously installed gasket to thereby deform an interior surface of the heated pipe;
separating the section of pipe from the forming collar and so that the heated pipe contracts about the gasket with the deformed interior surface comprising a gasket groove in the mouth opening of the pipe;
removing the pipe with the previously installed gasket from the forming mandrel.

7. The method of claim 6, wherein the band is located in proximity with an outer surface of the gasket body, whereby the band provides a reinforced contact point during the steps of forming the pipe groove, while being totally enclosed within the material of the gasket body.
